(19) United States
(12) Patent Application Publication
(10) Pub. No.: US 2012/0044727 A1
(43) Pub. Date: Feb. 23, 2012

(54) METHOD AND CIRCUIT ARRANGEMENT FOR SUPPLYING A MULTIPHASE ELECTRICAL NETWORK

(75) Inventor: Matthias Bartsch, Bremen (DE)

(73) Assignee: POWERWIND GMBH, Hamburg (DE)

(21) Appl. No.: 13/145,538

(22) PCT Filed: Jan. 20, 2009
(86) PCT No.: PCT/EP2009/000326

§ 371 Date: Nov. 8, 2011

(51) Int. Cl. H02M 7/537; H02M 7/5383

(52) U.S. Cl. 363/74; 363/131

(57) ABSTRACT

In a method for supplying a multiphase electric network (17) by means of an electric generator (1) of a regenerative power source, the generator being connected to the network (17) via a converter (4 to 12), by which the amplitude of the fed current and the phase angle thereof relative to the voltage can be controlled, according to the invention the controls for the individual phases are carried out independently of one another.

The invention relates to a method for supplying a multiphase electric network by means of an electric generator of a regenerative power source, the generator being connected to the network via a converter, by which the amplitude of the fed current and the phase angle thereof relative to the voltage can be controlled, and to a circuit assembly suited therefor.

Such known methods and circuit assemblies already make it possible to adjust the provision of reactive power in a range that is required by the network operators. In addition, additional reactive current can be provided by way of the control when network faults occur (mode: overexcited operation). In the case of asymmetric faults, for example double-phase faults of a three-phase power system, primarily one of the three phase-to-phase voltages changes, and the provision of the additional reactive current is generally only required for the phases in which a change of the phase-to-phase voltage takes place. Such control, however, is not possible with the known methods and circuit arrangements, notably in wind power plants and three-phase power networks.

It is the object of the invention to refine a method and a circuit assembly of the type mentioned above to the effect that they are suited for voltage back-up when experiencing network-related voltage unbalances.

According to the invention, this object is achieved by carrying out the controls for the individual phases independently of one another.

Because according to the invention the controls for the individual phases are independent of one another, unbalanced currents can be fed for voltage back-up when network-related voltage unbalances and the associated undervoltages occur.

In a circuit assembly according to the invention that is suitably designed for this purpose, the feed units are separated for each phase. For this reason, no cross-circuits can occur between the individual outer conductor currents. Moreover, a rigid connection of the converter intermediate circuit to ground potential is avoided and the intermediate circuit is thereby decoupled from ground potential. For this purpose, in an advantageous embodiment, for each phase of the network the converter comprises an intermediate circuit that is supplied by a generator-side converter and a line-side converter that is supplied by the intermediate circuit and forms the feed unit for the respective phase. The separate controllability of these converters enables the independent current feed of the phases.

For passing through a network-related voltage unbalance, the converter is controlled such that the amplitude of the current is increased and/or the phase angle relative to the voltage is controlled to a value that is close to or exactly 90° (mode: overexcited operation) for a phase that has dropped to an undervoltage. The current amplitude in the other phases is minimized. In addition or as an alternative, the phase angles in these other phases are controlled to values that considerably deviate from the phase angles of the normal, symmetric situation.

A particularly important field of application of the method according to the invention and of the circuit assembly according to the invention is the network supply by wind power plants, in particular the supply of three-phase power networks.

Additional characteristics and details of the invention will be apparent from the following description which explains the invention by way of example based on the drawings. In the drawings:

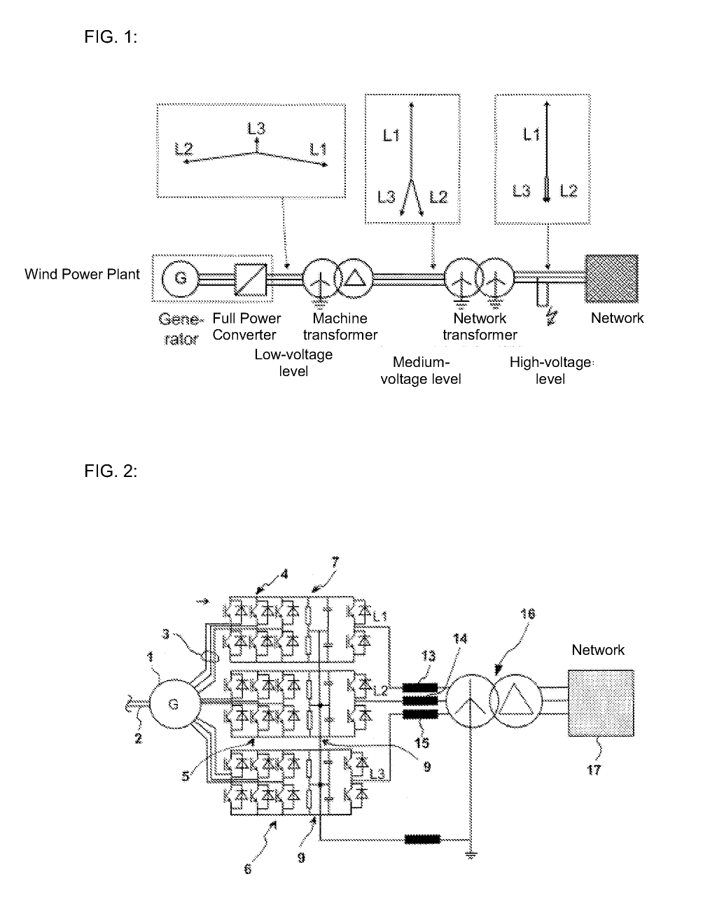

FIG. 1 shows an example of an asymmetric network fault at the high-voltage level and the transfer thereof to the low-voltage side of the machine transformer,

FIG. 2 is a circuit assembly according to an exemplary embodiment of the invention.

FIG. 1 explains, by way of example, how a double-phase network fault occurring at the high-voltage level affects lower voltage levels. The low-voltage level of a wind power plant is connected by means of the machine transformer interconnected as a Dyn5 vector group to a medium voltage level, which in turn is connected to the high-voltage level by means of a network transformer. According to the phasor diagram drawn over the high-voltage level, phases L2 and L3 are affected by the network fault, while phase L1 is not. In this case, the phasors of phases L2 and L3 are directed opposite to the phasor of phase L1 and have a shorter length than the latter. The phasor diagrams drawn over the medium-voltage level and the low-voltage level show how the fault occurring at the high-voltage level is transferred to these lower levels.

FIG. 2 shows a three-phase generator (three-phase synchronous generator or three-phase asynchronous generator) 1, the drive shaft 2 of which is driven by a wind turbine, which is not shown. Three generator-side converters 4, 5, 6 are connected in parallel to one another to the three outer conductors 3 of the three-phase generator 1. It is apparent from FIG. 2 that each of these generator-side converters 4, 5, 6 is a six-pulse three-phase IGBT converter, which supplies a DC voltage intermediate circuit 7, 8 or 9 connected thereto.

A line-side converter 10, 11 or 12 is connected to each of the DC voltage intermediate circuits 7, 8, 9. It is apparent from FIG. 2 that these line-side converters are likewise controlled IGBT converters, the respective output of which supplies one of three phases L1, L2 and L3 for supplying a three-phase power network. The phases L1, L2 and L3 are connected by means of network connection chokes 13, 14 or 15 to the low-voltage side of a star-delta transformer 16, the high-voltage side of which is connected to the three-phase network 17. The center taps of the three DC voltage intermediate circuits 7, 8, 9 are connected to the neutral point of the star-delta transformer 16 by means of a network connection choke 18. This neutral point is grounded.

It is apparent from FIG. 2 that the converter assembly 4 to 12 forms a full power converter, the IGBTs of which can be controlled independently for each of the three phases. In this way, different target values for the current amplitude and for the phase angle relative to the voltage can be predefined for each of the three phases. The actuation is selected so that the inverter current is considerably increased in a phase affected by a voltage dip and fed to a value that is close to or exactly 90° offset from the voltage so as to raise the voltage the largest extent possible (mode: overexcited operation). The current in the two other phases is either minimized or fed with phase angles that considerably deviate from the symmetric case of phase angles offset 120° from one another.

### LIST OF REFERENCE NUMERALS

1 Three-phase generator
2 Drive shaft
3 Outer conductor
4, 5, 6 Generator-side converters
7, 8, 9 DC voltage intermediate circuit
10, 11 , 12 Line-side converters
13, 14, 15 Network connection chokes
16 Star-delta transformer
17 Network
18 Network connection choke

1. A method for supplying a multiphase electric network by means of an electric generator of a regenerative power source, the generator being connected to the network via a converter, by which the amplitude of the fed current and the phase angle thereof relative to the voltage can be controlled, characterized in that the controls for the individual phases are carried out independently of one another.

2. The method according to claim 1, characterized in that for passing through a network-related voltage unbalance, the phase angle of the current relative to that of the voltage is controlled to a value close to or exactly 90° (mode: overexcited operation) for a phase that has dropped to an undervoltage.

3. The method according to claim 1, characterized in that for passing through a network-related voltage unbalance, the amplitude of the current is increased for a phase that has dropped to an undervoltage.

4. A method according to claim 1, characterized in that for passing through a network-related voltage unbalance, the amplitude of the current is decreased for a phase that has not dropped to an undervoltage.

5. A method according to claim 1, characterized in that for passing through a network-related voltage unbalance, the phase angle of the current is controlled to a value that deviates from the value thereof that corresponds to the symmetry for a phase that has not dropped to an undervoltage.

6. A method according to claim 1, characterized in that the regenerative power source is a wind power plant.

7. A method according to claim 1, characterized in that the network is a three-phase power network.

8. A circuit assembly for supplying a multiphase electric network by means of an electric generator of a regenerative power source, the generator being connected to the network via a converter, by which the amplitude of the fed current and the phase angle thereof relative to the voltage can be controlled, characterized in that the controls for the individual phases can be carried out independently of one another.

9. The circuit assembly according to claim 8, characterized in that for each phase of the network, the converter comprises an intermediate circuit that is supplied by a generator-side converter and a line-side converter that is supplied by the intermediate circuit.

10. The circuit arrangement according to claim 9, characterized in that the generator is multiphase and each generator-side converter is supplied by all phases of the generator.

11. A circuit assembly according to claim 8, characterized in that the converter is connected to the network via a star-delta transformer.

12. A circuit assembly according to claim 8, characterized in that the regenerative power source is a wind power plant.

13. A circuit assembly according to claim 8, characterized in that the network is a three-phase power network.

14. A circuit assembly according to claim 8, characterized in that the generator is a three-phase generator.
